(19) United States
(12) Patent Application Publication
(10) Pub. No.: US 2005/0253921 A1
(43) Pub. Date: Nov. 17, 2005

(54) Method and device for producing a charge image by illumination lines whose deviations are minimised by a target line

(75) Inventor: Hans-Detlef Groeger, Poing (DE)

Correspondence Address: SCHIFF HARDIN, LLP;PATENT DEPARTMENT, 6600 SEARS TOWER, CHICAGO, IL, 60606-6473, US

(73) Assignee: Oce' Printing Systems GmbH, Poing (DE)

(21) Appl. No.: 10/531,370

(22) PCT Filed: Oct. 24, 2003
(86) PCT No.: PCT/EP03/11857

§ 371 Date: Jul. 7, 2005

(30) Foreign Application Priority Data
Oct. 24, 2002 (DE) 102 49 672.2

(51) Int. Cl. B41J 2/435

(52) U.S. Cl. 347/229

(57) ABSTRACT

A method or system is provided for producing a charge image on an intermediate carrier of an electrophotographic printer or copier. A character generator having a plurality of light sources arranged in at least one row in groups is provided. A separate functional unit is provided for each light source group for control of the light sources. The functional unit is connected with a central control unit, the functional unit comprising an address system via which it can be activated, and a control unit. The light sources of each group are controlled by said control unit assigned to the functional unit. The at least one row of light sources is imaged onto the intermediate carrier as an exposure line, the intermediate carrier being displaced substantially transverse to the exposure line relative to the character generator. A temporal beginning of illumination phases of groups of light sources is selected such that deviations of the exposure line from a target line is reduced.

### BACKGROUND

The present preferred embodiment relates to a method and a device for producing a charge image on an intermediate carrier of an electrophotographic printer or copier with the aid of a character generator that has a plurality of light sources arranged in at least one row, the at least one row of light sources being imaged on the intermediate carrier as an exposure line, and the intermediate carrier being movable relative to the character generator, essentially transverse to the exposure line.

From EP 0 971 310 B1, a character generator is known having a plurality of light sources that are arranged in a row. The row of light sources is imaged on an intermediate carrier of a printer or copier as an exposure line, and thereby produces a line of a latent charge image on a photoconductive coating of the intermediate carrier. Here, each light source of the character generator is provided for the production of one image point of the charge image, i.e., the density of the arrangement of the light sources on the character generator corresponds to the resolution of the image.

The intermediate carrier is displaced transverse to the direction of the exposure lines relative to the character generator, so that a two-dimensional charge image is produced on the intermediate carrier through successively imaged exposure lines. For this purpose, the intermediate carrier is formed for example as a photoconductor drum that rotates about its center axis, or as a revolving photoconductor belt. The charge image on the intermediate carrier is developed in a known manner and the developed image is transferred to a recording medium.

Because the light sources of the character generator are imaged immediately to an exposure line on the intermediate carrier, mechanical imprecision, both in the orientation of the character generator relative to the intermediate carrier and within the character generator (e.g. in the arrangement of the light sources or of the lens system, or due to mechanical tensions), can cause the exposure line to deviate from a target line. The precision in the design and installation of the character generator required to produce a satisfactory print image requires a significant expense, resulting in significant costs in currently used printers and copiers.

Particularly high demands on precision are made in color printing according to what is known as the “single pass” method, in which a recording medium (e.g., a single piece of paper or an endless web of paper) is guided through a plurality of separate imaging units, each of which contributes a color component of a color image (e.g., red/green/blue or cyan/magenta/yellow/black). Each of these imaging units has a character generator of the type cited above. If the exposure line of one or more of these character generators deviates from the associated target line, the colors are not combined in the planned fashion, resulting in very disturbing distortions of the color.

From U.S. Pat. No. 6,215,511 B1, it is known in principle to correct mechanical imprecision in a character generator through a suitable selection of the temporal beginning of the illumination phases of individual groups of light sources. For this purpose, essentially two methods are indicated. In a first method, all the print data of a line are periodically written to a latch register, and are kept constant during a line period, that is, during the time interval provided for writing an image line on the intermediate carrier. Then, with the aid of delay circuits connected subsequent to the latch register, the temporal beginning of the illumination phase of a group of light sources can be displaced in order to reduce deviations between the part of the image line that corresponds to the group of light sources and a target line. However, this correction can be carried out only within the temporal limits of such a line period. This means on the one hand that only corrections whose height is less than that of a print line (i.e., the height of a pixel) are possible in the print image. On the other hand, this method is not practicable in printers or copiers having a high processing speed, with a correspondingly short line period, because in these cases the illumination phase duration required for the exposure of the intermediate carrier already makes up a significant portion of the line period, so that the beginning of the illumination phase can no longer be shifted significantly within the line period.

In the second method from the above-cited reference, a print line correction is made by using different groups of light sources to simultaneously expose segments of different print lines. This means that the beginning of the illumination phase of a light source group cannot be shifted continuously, but rather only in whole-number multiples of a line period. This method does in principle enable the correction of gross print image deviations, but only up to the degree of precision of a line spacing, which does not result in advantageous print image quality.

Additional prior art references include U.S. Pat. No. 6,201,596 B1 and EP 0 367 550 A2.

### SUMMARY

It is an object to provide a method and a device that enable the production of a high-quality charge image at a moderate expense.

A method or system is provided for producing a charge image on an intermediate carrier of an electrophotographic printer or copier. A character generator having a plurality of light sources arranged in at least one row in groups is provided. A separate functional unit is provided for each light source group for control of the light sources. The functional unit is connected with a central control unit, the functional unit comprising an address system via which it can be activated, and a control unit. The light sources of each group are controlled by said control unit assigned to the functional unit. The at least one row of light sources is imaged onto the intermediate carrier as an exposure line, the intermediate carrier being displaced substantially transverse to the exposure line relative to the character generator. A temporal beginning of illumination phases of groups of light sources is selected such that deviations of the exposure line from a target line is reduced.

### BRIEF DESCRIPTION OF THE DRAWINGS

FIG. 1 shows a schematic representation of the design and the functioning of a character generator according to the prior art;

FIG. 2 shows a schematic representation of the design and the functioning of a character generator according to preferred embodiment; and

FIG. 3 shows a schematic representation of an exposure line produced according to the prior art and of an exposure line produced according to the preferred embodiment.

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to the preferred embodiment, instead of minimizing imaging errors by means of ever-greater precision in the design and installation of the character generator, it is proposed to accept a certain amount of design-caused imaging error, and to correct this error through a suitable selection of the temporal beginning of the illumination phases of individual light sources or of groups of light sources.

In order to achieve this, for each group of light sources a separate functional unit is provided for controlling the light sources, and the light sources of each group are controlled by a control unit associated individually with each functional unit. Through the use of a separate control unit for each group of light sources, the light source groups can be controlled completely independently of one another, so that the character generator can be constructed as a row of small elementary character generators, each comprising a group of light sources. In this way, all the adjustment techniques known from conventional character generators, relating to light intensity, illumination phase duration, and temporal beginning of the illumination phase, can be carried out individually for each of these elementary character generators in the method and device of the preferred embodiment. In particular, the control units of the functional units can control the light source groups independent of a clock pulse that is predetermined by the line period provided for the processing of a print line. This represents an immense advantage over the device and the method from the above-cited US patent, in which the controlling of the groups of light sources is coupled rigidly to the clock pulse of the line period, so that only very small or else very large variations of the beginning of the illumination phase are possible.

In an advantageous development, the functional units are connected to a central control unit, and they have an address via which they can be controlled in a targeted manner. In an advantageous development, the central control unit gives an individual start command to the control unit of each functional unit for the controlling of the associated light source group, the time of the start command being selected such that a deviation of the exposure line segment corresponding to the light source group from the target line is minimized.

This start signal can take place completely independently of the other light source groups, and independently of the processing and the reading in of the print image data. In this way, it is achieved that the beginning of the illumination phase of the light source group can be selected completely freely. It can be achieved that the center of the correspondingly recorded image point is situated in the center of the line height of an ideal line. In this way, image errors in homogenous images, in particular interference errors, can be avoided.

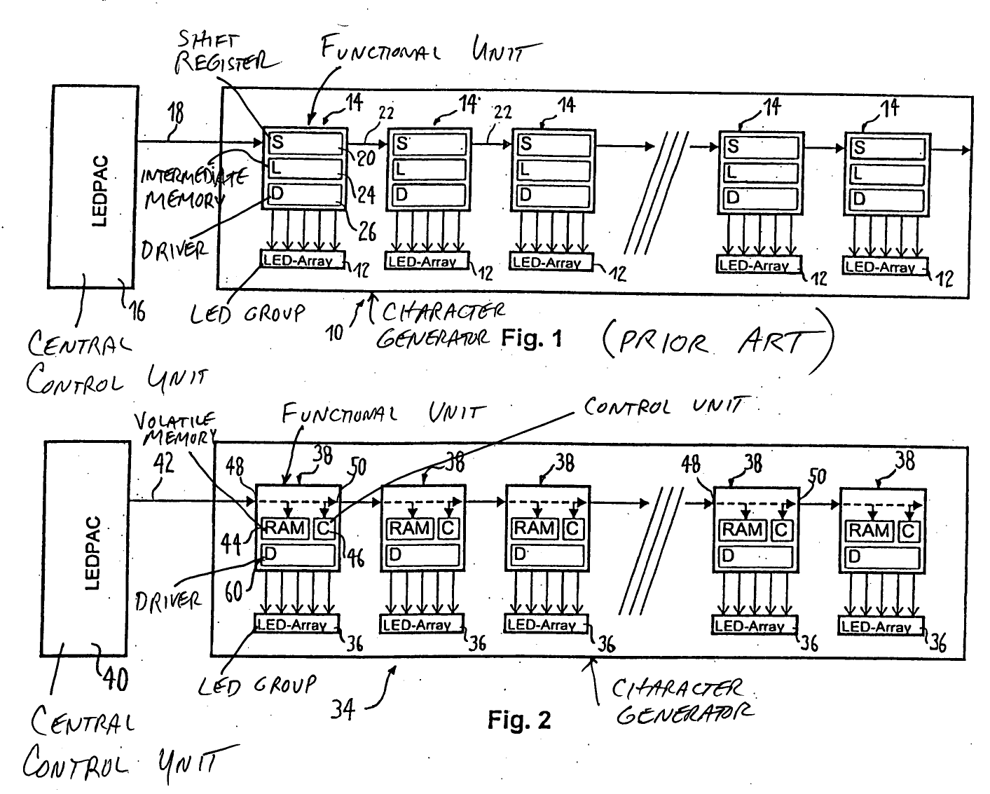

In FIG. 1, the design of a character generator 10 known from the prior art is shown schematically. Character generator 10 is described in detail in the above-cited EP 0 971 310 B1, whose content is incorporated through reference into the present description. Character generator 10 has, over a width of 20.48 inches, a row of light sources formed from 12,288 LEDs. The LEDs are for example imaged via a SELFOC lens onto an intermediate carrier (not shown) to form an exposure line, each LED being assigned to the production of one image point. From the number of LEDs and the length of the row of LEDs, a print image resolution of 600 dpi results.

As is shown schematically in FIG. 1, the LED row is made up of separate LED groups 12 (LED arrays), each of which is connected to an associated functional unit 14 for controlling the LEDs. In the depicted exemplary embodiment, functional unit 14 is formed by an integrated circuit. Conventional character generator 10 in FIG. 1 typically has 192 LED groups 12, each having 64 LEDs and an associated functional unit 14. In addition, character generator 10 has a central control unit 16 (LEDPAC, or LED Print Array Controller) for controlling character generator 10.

In the following, the conventional method for producing a charge image on an intermediate carrier with the aid of conventional character generator 10 is briefly explained. Central control unit 16 sends print data via a data line 18 to a shift register 20 of first functional unit 14 (i.e., the one situated the furthest to the left in FIG. 1). The functional units 14 that are adjacent to shift register 20 are connected to one another by lines 22, and the print data are forwarded by shift register 20 to all functional units 14 until shift register 20 of final functional unit 14 (i.e., the one situated the furthest to the right in FIG. 1) is filled with print data.

The print data are made up of an eight-bit-long data word for each LED of character generator 10, representing the duration of the illumination phase of the corresponding LED. The duration of the illumination phase is the product of two factors, namely a desired illumination intensity on the one hand and a correction factor on the other hand. In the simplest case, the desired illumination intensity can be represented by a one-bit signal (LED on or LED off). This is called bilevel printing. However, in order to produce a plurality of gray tones it is advantageous to provide a plurality of levels of illumination intensity; i.e., illumination phases of different lengths. This method is called multilevel printing, and is standard practice has four, 8, or 16 levels of illumination intensity. The correction factor is used to compensate fluctuations in the individual illumination intensity of the LEDs, resulting from aging or from manufacturing irregularities.

After shift registers 20 of all functional units 14 of character generator 10 have been filled with print data, they are transferred to an intermediate memory 24 (latch L). With the aid of a driver 26 (driver D), the LEDs of the associated LED array 12 are then simultaneously switched on, and are then switched off again after the corresponding illumination phase duration, stored in intermediate memory 24, has elapsed (if an illumination phase duration has length 0, the corresponding LED is not switched on at all). During the illumination phase of the LEDs, the print data for the exposure of the following line are placed in shift register 20 of all functional units 14. Further details concerning the design and function of functional units 14 can be found in the above-cited reference EP 0 971 310 B1, and are not further described here.

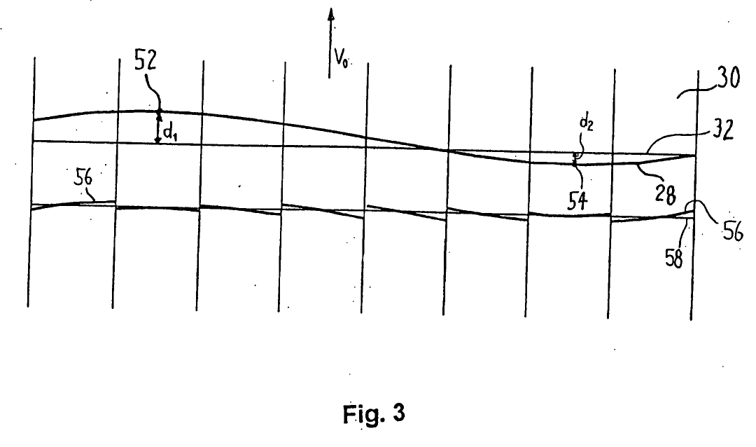

The LED row of character generator 10 is imaged onto an intermediate carrier 30 with the aid of a known SELFOC lens (not shown) as an exposure line 28 (see FIG. 3), which moves with velocity v₀ relative to character generator 10, in the direction indicated by the velocity arrow in FIG. 3.

Due to mechanical imprecisions in the design of character generator 10 or in the installation of character generator 10 in a printer or copier, exposure line 28 can deviate from a target line 32. In the schematic representation of FIG. 3, the vertical lines indicate the boundaries of LED array 12; i.e., the segments of exposure line 28 that are situated between two vertical lines are produced by exactly one LED array. For simplicity, in the simplified representation of FIG. 3, exposure line 28 is divided into only eight segments; i.e., the character generator corresponding to this simplified representation would be provided with only eight LED arrays.

In conventional character generator 10, the deviations of exposure line 28 from target line 32 can be kept small only at an enormous mechanical expense. In particular, continuous, smooth deviations of exposure line 28 from target line 32, as are shown in FIG. 3, are typical, and result for example from tension or sagging of character generator 12. Such deformations can be removed only with difficulty through subsequent adjustment.

In black-and-white printing, a fairly smooth, uniform deviation of exposure line 28 from target line 32 in the resulting print image may not be regarded as disturbing, because it will not ordinarily be detected by the naked eye. In contrast, in single-pass color printing, in which a plurality of character generators contribute to the production of the color components of a color image, such deviations result in a disturbance of the color convergence, and are absolutely unacceptable.

FIG. 2 shows a character generator 34 according to the development of the preferred embodiment. Similar to character generator 10 from the prior art, in character generator 34 the light sources are formed by LED groups 36 (LED arrays) that are controlled via an associated functional unit 38. Character generator 34 is also provided with a central control unit 40. An important difference from the prior art is in the design of functional units 38 and in the operation of character generator 34, as described in the following.

Instead of shift register 20, character generator 34 has an internal bus 42 and a volatile memory (RAM 44). Moreover, each functional unit 38 of character generator 34 has a separate control unit (controller C) 46. Internal data bus 42 has 16 data lines, and optionally has a 17^{th} command line. It is an internal bus insofar as it creates a connection only between functional units 38, which are thus arranged operatively in a row. Each functional unit 38 has an input interface 50 via which it can receive data and a clock signal from the functional unit that precedes it in the row (situated to the left in FIG. 2), and an output interface via which functional unit 38 can forward data and a clock signal to the functional unit that is subsequent in the row (situated to the right in FIG. 2). Between the reception and the forwarding of data by a functional unit 38, there is a system clock in which the clock signal is reproduced. Each functional unit 38 has an address and an address decoder (not shown), so that it can be addressed in targeted fashion.

In the following, the functioning of character generator 34 is explained. Central control unit 40 sends the print data to the relevant functional unit 38 via internal bus 42. A special data protocol is used for this purpose that can transmit control information as well as data packets. Control information of this sort includes, among other things, the address of the functional unit 38 for which the data packet is destined. As described above, the data and control information are passed through all the functional units 38. If, during this process, a functional unit 38 recognizes, on the basis of the address contained in the control information, that the data is destined for it, it stores this data in its memory 44.

The print data are essentially identical to those of character generator 10 of the prior art. However, in character generator 34 only the desired illumination intensity for each LED is required, but not the correction factor, which is independent of the print image. Instead, the correction factors are stored in memory 44. This significantly reduces the quantity of data required for the printing of a line.

A main difference of the functioning of character generator 34 from that of the conventional character generator is that not only the length of the illumination phases of the LEDs is controlled individually, but also the beginning of these phases, at least for the groups. For each LED group 36, central control unit 40 determines the beginning of the illumination phase of the LEDs. This means that the illumination phases of all light sources within a group are initiated by a common controlling (in this case, by central control unit 40).

Because intermediate carrier 30 is displaced relative to the character generator, a temporal shifting of the illumination phase brings about a spatial shifting of the corresponding segment of exposure line 28 on intermediate carrier 30. This shifting is used to minimize deviations of exposure line 28 from target line 32.

The method is now explained in more detail with reference to FIG. 3. First, it is noted that in relation to velocity v₀ with which intermediate carrier 30 is displaced relative to character generator 34, or generator 10, the illumination phases are extremely short, because otherwise the charge image would be smudged. For the explanation of the method, two points 52 and 54 of exposure line 28 in FIG. 3 are taken as examples. Exposure points 52 and 54 were produced “simultaneously”; i.e., the illumination phases of the two corresponding LEDs began at the same time, hereinafter called the reference time, and the durations of the illumination phases are negligible in this context.

As can be seen in FIG. 3, exposure point 52 is offset in relation to target line 32 by a distance d₁ in the direction of relative velocity v₀ of intermediate carrier 30 relative to character generator 10, or generator 34. This means that exposure point 52 would lie on the target line if the corresponding LED had been switched on at a time t₁=d₁/v₀ after the reference time. In contrast, exposure point 54 is offset in relation to target line 32 by a distance d₂ opposite the direction of velocity v₀. Accordingly, the deviation of exposure point 54 from target line 32 can be corrected by making the illumination phase of the corresponding LED earlier in relation to the reference time by t₂=d₂/v₀.

In this way, in principle the deviation of each exposure point from target line 32 can be corrected. In order to limit the expense for the control logic circuitry and for the quantity of data to be transmitted, it is advantageous, instead of predetermining the beginning of the illumination phase individually for each LED, to predetermine it for all the LEDs of an LED group 36 in the context of a common controlling. As a rule, this means that the illumination phases of the LEDs of a group will essentially begin simultaneously.

The result of this method is shown in exposure line 56, which corresponds in principle to exposure line 28, except that the temporal beginning of the illumination phase for each LED group 36 has been selected such that the corresponding segment of exposure line 56 deviates as little as possible from target line 58.

In character generator 34 in FIG. 2, central control unit 40 sends the signal for the beginning of the illumination phase of each LED group 36 to the corresponding functional unit 38. Upon receiving the signal, the control unit 46 associated individually with functional unit 38 initiates the beginning of the illumination phase, with the aid of a driver 60 that does not differ essentially from driver 26 of conventional character generator 10.

As can be seen in FIG. 3, discontinuities occur in exposure line 56 if the temporal beginning of the illumination phase of adjacent LED groups 36 differs. This means that in adjacent LED groups, the temporal beginning of the illumination phases must not differ too greatly, because otherwise discontinuities would become visible in the print image. In order to gain an idea of the order of magnitude of the corrections that can be achieved with character generator 34 and the presented method, suppose that the exposure line stands oblique to the target line, with a simultaneous beginning of all illumination phases. If an offset of half the size of a pixel is tolerated at the boundaries of the exposure line segments, then, given 192 LED groups and a pixel size of 1/600 inches, a compensatable overall offset of the ends of character generator 34 of 4.06 mm is obtained, which is many times the imprecision encountered in standard practice.

The temporal shifting of the illumination phases has the result that the character generator simultaneously produces segments of different exposure lines. In the above example of the obliquely situated character generator, if a spatial offset of half a pixel size is again tolerated at the segment boundaries of an exposure line, the number of segments of lines that are simultaneously printed is half the number of LED groups 36 that character generator 34 has. In the depicted exemplary embodiment of character generator 34 in FIG. 2, this means that segments of 96 different print lines are generated simultaneously. Therefore, memory 44 must have space for the print data of at least 96 lines.

In the depicted exemplary embodiment, the beginning of the illumination phase of each LED group is predetermined by central control unit 40. Because the temporal offset of the beginning of the illumination phase of each LED group 36, which minimizes the deviation of the corresponding segment of exposure line 56 from target line 58, is independent of the print data, this offset could also be stored in memory 44 of each functional unit 38, and the controlling of LED group 36 could be initiated by control unit 46 with a suitable offset in relation to a reference time.

Although a preferred exemplary embodiment has been indicated and described in detail in the drawings and the above description, this should be understand as purely exemplary, and should not be regarded as limiting the present invention. It is to be noted that only the preferred exemplary embodiment has been presented and described, and that all changes and modifications lying within the scope of protection of the present invention currently and in the future are to be protected.

1-15. (canceled)

16. A method for producing a charge image on an intermediate carrier of an electrophotographic printer or copier, comprising the steps of:
providing a character generator having a plurality of light sources arranged in at least one row in groups;
providing a separate functional unit for each light source group for control of the light sources;
connecting the functional unit with a central control, unit the functional unit comprising an address decoder, an address via which it can be specifically activated, and a control unit;
controlling the light sources of each group by said control unit assigned to the respective functional unit;
imaging the at least one row of light sources onto the intermediate carrier as an exposure line, the intermediate carrier being displaced substantially transverse to the exposure line relative to the character generator; and
selecting a temporal beginning of illumination phases of groups of light sources such that deviations of the exposure line from a target line are minimized.

17. A method according to claim 16 in which the control units of the functional units control the light source groups independently of a clock pulse that is predetermined by a line period provided for processing of a printed page.

18. A method according to claim 16 in which the control unit of each functional unit is controlled by the central control unit in order to initiate the illumination phase of the associated light source group.

19. A method according to claim 18 in which the central control unit gives the control unit of each functional unit an individual start command for controlling the associated light source group, a time of the start command being selected such that a deviation of the exposure line segment corresponding to the light source group from the target line is minimized.

20. A method according to claim 16 in which the functional units are arranged operatively in a row, and receive at least one of the elements selected from the group consisting of data and a clock signal via an input interface, and, except for a last functional unit in the row, forward these data or the signal to the next functional unit in the row via an output interface.

21. A method according to claim 20 in which between the reception and the forwarding of the data or of the clock signal there is situated a system clock in which the clock signal is reproduced.

22. A method according to claim 16 in which data are stored in a volatile memory that is separately assigned to the functional unit.

23. A method according to claim 22 in which the data comprise print data for the segments, corresponding to the light source group, of a plurality of lines to be printed.

24. A method according to claim 22 in which the data comprises a correction parameter for each light source of the group that represents its individual illumination intensity.

25. A device for producing a charge image on an intermediate carrier of an electrophotographic printer or copier, comprising:
a character generator that has a plurality of light sources arranged in at least one row in groups;
a separate functional unit for each light source group for controlling of the light sources;
the functional unit is connected with a central control unit, the functional unit comprising an address decoder, an address via which it can be specifically activated, and a control unit;
the light sources of each group being controlled by said control unit assigned to the respective functional unit;
the at least one light source row is imaged as an exposure line onto the intermediate carrier, and the intermediate carrier is displaced substantially transverse to the exposure line relative to the character generator; and
a temporal beginning of the illumination phases of groups of light sources is selectable such that deviations of the exposure line from a target line are minimized.

26. A device according to claim 25 in which the light source groups are each controllable by the control unit of the associated functional unit independently of a clock pulse that is predetermined by a line period provided for processing of a print line.

27. A device according to claim 25 in which the control unit of each functional unit is controlled by the central control unit in order to initiate the illumination phase of the associated light source group.

28. A device according to claim 27 in which the central control unit is programmed in such a way that it gives the control unit of each functional unit an individual start command for controlling the associated light source group, a time of the start command being selected such that a deviation of the exposure line segment corresponding to the light source group from the target line is minimized.

29. A device according to claim 25 in which the functional units are arranged operatively in a row, the functional units having an input interface for receiving one of the elements selected from the group consisting of data and a clock signal, and the functional units, with the exception of a last functional unit in the row, having an output interface for forwarding the data or the clock signal to the following functional unit in the row.

30. A device according to claim 25 in which the functional units have a volatile memory.

31. A method for producing a charge image on an intermediate carrier of an electrophotographic printer or copier, comprising the steps of:
providing a character generator having a plurality of light sources arranged in at least one row in groups;
providing a functional unit for each light source group for control of the light sources;
connecting the functional unit with a central control unit the functional unit comprising an address system via which it can be activated and a control unit;
controlling the light sources of each group by said control unit assigned to the respective functional unit;
imaging the at least one row of light sources onto the intermediate carrier as an exposure line, and
selecting a temporal beginning of illumination phases of at least two groups of light sources such that deviations of the exposure line from a target line are reduced.
